(19) United States
(12) Patent Application Publication
(10) Pub. No.: US 2009/0324919 A1
(43) Pub. Date: Dec. 31, 2009

(54) LAYERS OR COATINGS WHICH ARE STABLE AT HIGH TEMPERATURES AND COMPOSITION FOR PRODUCING THEM

(75) Inventors: Dimitrina Lang, Neunkirchen (DE); Stefan Faber, Saarbrucken (DE); Ralph Nonninger, Saarbrucken (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Itn Nanovation AG, Saarbrucken (DE)

(21) Appl. No.: 12/304,787

(22) PCT Filed: Jun. 14, 2007
(86) PCT No.: PCT/EP2007/005256

§ 371 Date: Jan. 6, 2009

(30) Foreign Application Priority Data
Jun. 16, 2006 (DE) 102006028963.3

(51) Int. Cl. B32B 18/00; C03C 8/14; C03C 8/20

(52) U.S. Cl. 428/220; 501/17; 501/18

(57) ABSTRACT

A composition for producing a layer or coating which is stable at high temperatures includes water glass, at least one glass frit, hard material particles and solvent.

### RELATED APPLICATION

This is a §371 of International Application No. PCT/EP2007/005256, with an international filing date of Jun. 14, 2007 (WO 2007/144178 A1, published Dec. 21, 2007), which is based on German Patent Application No. 102006028963.3, filed Jun. 16, 2006.

### TECHNICAL FIELD

This disclosure relates to a composition, a kit for producing. such a composition, its use as a coating composition, in particular for producing layers or coatings which ate stable at high temperatures, a process for producing such layers or coatings, the layers and coatings themselves which can be produced from the composition and also articles which are at least partly coated with such a layer or coating.

### BACKGROUND

In reactors and combustion plants, for example, in power stations fired with hard coal and brown coal and also in waste incineration plants, plant components such as, in particular, steel pipes, steel pipe assemblies, waste heat boilers, electrofilters, air preheaters and steam/gas preheaters are subjected to high temperatures and attack by corrosive gases and especially by corrosive solids. To protect against such attack, components of this type can, for example, be lined with refractive compositions, concrete or bricks. However, this is possible only in particular regions of the reactors and combustion plants.

An even greater problem in reactors and combustion plants is that during operation, in particular in waste incineration plants, corrosive solids and ashes deposit on the abovementioned plant components or on the refractory lining and these can inhibit heat transfer from the combustion chamber to the wall of heat-exchange tubes. These deposits represent a great problem since they have to be removed at regular intervals, either during operation, for example, by means of water lances or soot blowers or, more frequently, while the plant is shut down, in particular by mechanical removal by means of sand blasting, brushes or by means of a pneumatic hammer. Both methods are very complicated and associated with high costs. Cleaning with the plant shut down requires not only a long downtime of the plant but also a high level of safety measures for cleaning personnel.

To solve these problems, EP 1 386 983 has proposed a coating containing boron nitride both directly for the assemblies of steel tubes and also for the refractory linings of pipe walls, which coating significantly reduces the deposits described and thus assists heat transfer which is uniform over the long term. The coating composition which is likewise proposed in EP 1 386 983 for producing such layers comprises, in particular, boron nitride, an inorganic, nano-size binder and a solvent.

However, the coating proposed has disadvantages of various types under particular conditions.

Thus, the coating is comparatively soft because of the high boron nitride content. At high flue gas velocities, it is therefore possible for the coating to be abraded away by the particles such as sand or SiO₂ present in the flue gas during operation.

Furthermore, the coating is usable up to about 850° C. since boron nitride begins to react with oxygen at this temperature and vaporizes as boric acid. In addition, the nanoparticles present in the coating sometimes have limited ability to react with the slag and ash constituents of flue gases at such high temperatures, which can be attributed to the high reactivity and the great sinterability of the nanoparticles.

The coating therefore gives efficient protection only at relatively low temperatures. Particularly in the case of low-alloy steel grades (e.g., construction steels such as ST 37), scale formation, i.e., oxidation of the steel, occurs at relatively high temperatures. This layer of scale adheres loosely and falls off with time, which may result in a protective layer present thereon also becoming detached. The reason for scale formation is that the coating according to EP 1 386 983 is not gastight and thus allows diffusion of oxygen or chlorine from acidic flue gases through the coating to the steel.

It could accordingly be helpful to provide a solution which makes efficient protection of the abovementioned power station and reactor components possible, even at high temperatures. In particular, it could be helpful to counter or prevent deposition of solids and ashes on these components and, in the case of metallic components, counter the abovementioned problem of scale formation.

### SUMMARY

We provide a composition for producing a layer or coating which is stable at high temperatures which includes water glass, at least one glass frit, hard material particles and solvent.

We also provide a layer or coating which is stable at high temperatures and includes the composition for producing a layer or coating.

We further provide a kit for producing the coating composition which includes a component A which includes at least partly of water glass and a component B which is free of water glass and includes at least one glass frit and hard material particles.

### DETAILED DESCRIPTION

Our compositions for producing a layer or coating which is stable at high temperatures comprise water glass, at least one glass frit, hard material particles and solvents. It is intended, in particular, for use in the power station and reactor field as indicated at the outset and also for use in concrete and cement works.

The term “water glass” refers to water-soluble alkali metal silicates which have been solidified from the melt, in particular potassium and sodium silicates, or their (viscous) aqueous solutions. Reference may be made to the corresponding definitions in relevant textbooks.

The water glass may comprise at least one potassium water glass. The water glass may also comprise at least one sodium water glass.

The water glass is preferably present in the form of its aqueous solution. In particular, it is also possible to use mixtures of a plurality of different water glasses.

Glass frits are vitreous systems in which water-soluble salts (sodium carbonate, borax and others) and also, if appropriate, further materials are bound in the form of silicates and thus converted largely into a water-insoluble form. Particular preference is given to glass frits which contain the known constituents SiO₂, B₂O₃, Al₂O₃, alkali metal and alkaline earth metal oxides together with at least one of the constituents TiO₂, ZnO, ZrO₂, CuO, MnO and NiO. In addition, the frits can further comprise, in particular, inorganic fluorides. The at least one glass frit is preferably added in milled form to the composition.

The composition may comprise a glass frit mixture which can be melted at temperatures below about 700° C., preferably below about 600° C., as at least one glass frit. Such a glass frit mixture is preferably free of BaO and/or ZrO₂. Such a glass frit mixture particularly preferably comprises, as chemical constituents, SiO₂, B₂O₃ and Al₂O₃ and the alkali metal/alkaline earth metal oxides Li₂O, Na₂O, K₂O and CaO together with at least one compound from the group consisting of TiO₂, ZnO, CuO, MnO and NiO. In addition, it can comprise at least one inorganic fluoride, in particular at least one alkali metal and/or alkaline earth metal fluoride. The composition containing such a glass frit mixture can particularly advantageously be hardened at relatively low temperatures (at or above about 500° C.).

The compositions can be hardened at higher temperatures (in particular above about 700° C.) and preferably contain, as at least one glass frit, a frit or frit mixture which preferably comprises, as chemical constituents, SiO₂, B₂O₃ and Al₂O₃ and the alkali metal/alkaline earth metal oxides Li₂O, Na₂O, K₂O and CaO together with at least one compound from the group consisting of BaO, TiO₂, ZnO, CuO, MnO, ZrO₂ and NiO. Preference is also given to the at least one glass frit comprising at least one inorganic fluoride, in particular at least one alkali metal and/or alkaline earth metal fluoride.

It is in principle possible to use all known glass frits and glass frit mixtures. However, preference is given to these having an average particle size of from about 1 μm to about 10 μm, in particular from about 1 μm to about 5 μm.

As hard material particles in the composition, preference is given to using particles which have a hardness of >6 on Mohs' scale.

The hard material particles are preferably siliceous particles, oxidic particles, particles of titanates, particles of zirconates, particles of zirconium phosphate, particles of chromite (FeCr₂O₄), particles of spinel compounds or mixtures of these particles.

The hard material particles particularly preferably comprise at least one member of the group consisting of magnesium aluminate, (Fe, Mg)Cr₂O₄, zirconium oxide, zirconium silicate, cordierite, mullite, sintered mullite, zirconium mullite, chromite, aluminum oxide, chromium oxide, calcium oxide, magnesium oxide and titanium dioxide particles.

The particle size of the hard material particles is in principle not critical. However, the hard material particles preferably have an average particle size of from about 1 μm to about 10 μm, in particular from about 1 μm to about 5 μm.

The solvent is preferably a polarized solvent, in particular water. However, it is in principle also possible for further polar components such as alcohols to be present.

However, it is in many cases desirable to dispense with organic constituents in the solvent because of their low vapor pressure and the risk of fire.

The composition may be essentially free of nanosize particles (namely particles having an average particle size of < about 1 μm), in particular particles having average particle sizes of < about 100 nm, preferably < about 200 nm. Particles in this size range can be very reactive, as has been mentioned at the outset, and undergo reactions, for example with particles present in the flue gas, at high temperatures. Accordingly, a composition which does not contain any such nanosize particles is better suited for use in high temperature ranges.

The composition may comprise boron nitride as an additional component. It has been found that a proportion of boron nitride has a positive effect on the flexibility, in particular the susceptibility to cracking and the elasticity, of the layer or coating to be produced. As mentioned at the outset, problems can occur at high temperatures in the case of layers and coatings containing boron nitride, but these are particularly advantageously overcome, which will be discussed in more detail below.

The composition may contain chromium(III) oxide as an additional component. It has been found that such an addition has a very positive effect on the functionality of the layer to be produced as protection against scale formation and corrosion.

The addition of a proportion of boric acid to the composition can also be preferred. The addition of boric acid can significantly improve the melting behavior of the at least one glass frit present in the composition.

Apart from the abovementioned components, the compositions can comprise further, preferably coarser (having particle sizes up to the millimeter range or even larger), inorganic particles and/or fibers, in particular as fillers.

The composition preferably has a solids content in the range from about 25% by weight to about 60% by weight, preferably from about 40% by weight to about 60% by weight, in particular about about 50% by weight. The amount of solvent present in the composition is not critical in principle and can be varied according to the use of the composition. Thus, the composition may be in the form of a paintable or sprayable suspension.

The composition preferably comprises at least one auxiliary additive. Auxiliary additives include commercial additives which can be added to viscous and low-viscosity compositions, in particular water-based compositions, in the production of the compositions, in particular additives which serve to adjust and stabilize the properties of the compositions, i.e., for example, Theological auxiliaries, thickeners, dispersants, antifoams and leveling agents. These auxiliary additives can be present either alone or in combination with one another in the surface coating composition.

The composition may have a proportion of organic constituents of less than about 5% by weight, preferably less than about 2% by weight, in particular less than about 1% by weight, particularly preferably less than about 0.5% by weight. The composition may also be free of organic constituents. For the present purposes, the term organic constituents encompasses all organic constituents with the exception of organic solvent components present in the composition. In particular, it refers to organic auxiliary additives such as organic dispersants.

Water glass is preferably present in the composition in an amount, based on the total weight of the solid constituents of the composition, of from about 1% by weight to about 30% by weight, in particular from about 1% by weight to about 20% by weight.

The at least one glass frit is preferably present in the composition in an amount, based on the total weight of the solid constituents of the composition, of from about 1% by weight to about 90% by weight, in particular from about 5% by weight to about 80% by weight.

The hard material particles are preferably present in the composition in an amount, based on the total weight of the solid constituents of the composition, of from about 1% by weight to about 80% by weight, in particular from about 10% by weight to about 80% by weight.

Taking the above disclosures into account, some particularly preferred compositions include:
1% by weight-10% by weight, preferably 4% by weight-10% by weight, of potassium water glass,
1% by weight-15% by weight, preferably 3% by weight-10% by weight, of at least one glass frit,
1% by weight-15% by weight, preferably 4% by weight-10% by weight, of aluminum oxide,
1% by weight-20% by weight, preferably 10% by weight-15% by weight, of zirconium oxide,
1% by weight-10% by weight, preferably 1% by weight-5% by weight, of magnesium oxide,
5% by weight-15% by weight, preferably 10% by weight-15% by weight, of boron nitride,
1% by weight-10% by weight, preferably 1% by weight-5% by weight, of chromium(III) oxide,
from 0.1% by weight to 5% by weight, preferably from 0.1% by weight to 1% by weight, of at least one auxiliary additive and
from 40% by weight to 60% by weight, preferably about 50% by weight, of water.

The constituents add up to 100% by weight of the composition. What has been said above with regard to the individual constituents is hereby expressly incorporated by reference.

Further preferred compositions include the following constituents:
1% by weight-10% by weight, preferably 1% by weight-5% by weight, of sodium water glass,
20% by weight-45% by weight, preferably 30% by weight-40% by weight, of at least one glass frit,
5% by weight-20% by weight, preferably 10% by weight-15% by weight, of aluminum oxide,
0.1% by weight-5% by weight, preferably 0.1 % by weight-2% by weight, of boric acid,
from 0. 1% by weight to 5% by weight, preferably from 0.1% by weight to 1% by weight, of at least one auxiliary additive and
from 40% by weight to 60% by weight, preferably about 50% by weight, of water.

These constituents add up to 100% by weight of the total composition.

The compositions are particularly suitable for use in combustion plants such as coal-fired and waste-fired power stations or in cement and concrete works. The compositions enable plant components such as steel pipes, assemblies of steel pipes, waste heat boilers, electrofilters, air preheaters and steam/gas preheaters in these plants and works to be provided with a layer or coating which efficiently counters the deposition of solids, slags and ashes on these components. In the case of metallic components, the layer or coating efficiently counters the problem of scale formation mentioned at the outset.

Such a layer or coating which is stable at high temperatures is also provided. This can be produced from the compositions.

It preferably has a vitreous matrix which is formed from the at least one glass frit of a composition during production of the layer or coating.

Furthermore, it preferably comprises a proportion of silicate, in particular potassium and/or sodium silicate. The proportion of silicate results from the proportion of water glass in the composition.

The hard material particles present in a composition are also correspondingly present in a layer or coating.

A layer or coating is generally produced by application, preferably by spraying or painting, of a composition to the article to be coated. The composition is then allowed to dry, preferably at room temperature, resulting in the composition solidifying because of the proportion of water glass which hardens at least partially even at room temperature. After drying, the layer or coating formed is preferably strengthened further by subjecting it to a heat treatment (for example in a furnace). In the power station or reactor field, this can advantageously occur simply by running-up the plant. At the high temperatures which occur here (the further strengthening is preferably carried out at at least about 400° C., in particular at least about 500° C., particularly preferably at least about 600° C.), the abovementioned vitreous matrix can be formed from the at least one glass frit of the composition. The silicates formed from the water glass and the hard material particles and, if appropriate, further constituents of the composition are preferably embedded in this matrix, in particular in uniformly distributed form.

Thus, a layer or coating may contain boron nitride particles. However, in contrast to the known coatings, these boron nitride particles do not vaporize completely as boric acid at relatively high temperatures, since they are largely protected by the abovementioned matrix from reactions with oxygen. The flexibility and elasticity of a boron-containing layer or coating is thus maintained even at high temperatures.

A layer or coating can comprise boric acid and/or chromium(III) oxide, corresponding to the composition used in each case in the production of the layer or coating.

As indicated above, a layer or coating is, in particular, essentially gastight. This is attributable to the vitreous matrix which makes the layer or coating essentially impermeable to oxygen and other gases. Accordingly, as mentioned above, the layer or coating provides effective protection against the abovementioned scale formation on steels which can be caused by reaction of the steel with oxygen or chlorine and in this way the layer or coating is distinguished from the known solutions.

The layer or coating also offers effective protection against attack by corrosive solids, even at high temperatures of up to about 1000° C. Caked deposits under strongly abrasive conditions are effectively avoided even at high temperatures over prolonged periods of time or occur to an at least much lesser degree. Correspondingly, costly maintenance work in plants having the layer or coating is required less frequently.

The hard material particles in a composition serve primarily to increase the abrasion resistance of a layer or coating. Even at high flue gas velocities, the layer or coating therefore has a high resistance to the mechanical stresses which occur.

The layer or coating preferably has a thickness of from about 10 μm to about 200 μm, preferably from about 20 μm to about 150 μm. The layer thickness can, in particular, be influenced by the method of application and by the consistency of the composition used.

We further provide articles coated at least partly with the layer or coating.

Such articles are preferably articles which are at least partly coated with the layers or coatings just described. It may be preferred that the articles are coated completely.

The articles are preferably articles made of metal, in particular of steel. These include, for example, the steel pipes mentioned at the outset (in particular heat-exchange tubes in combustion plants or reactors), assemblies of steel pipes, waste heat boilers, electrofilters, air preheaters and steam/gas preheaters.

However, mineral substrates can also be coated very well with the composition. These include, in particular, articles made of refractory materials (refractory bricks and refractory concretes) such as chamotte, Ca silicate and SiC.

Finally, we provide for the use of a composition as coating composition, in particular for producing a layer or coating which is stable at high temperatures, preferably on the above-mentioned articles.

It has surprisingly been found that the layer or coating is particularly suitable as protection against deposits and caked material of a metallic type, as can occur, for example, in foundries, especially in aluminum foundries. Furthermore, the layer or coating also counters crystalline deposits, in particular adhering salts of all types, e.g., sodium chloride, CaSO₄ and lime, as can occur, for example, in water treatment plants.

Accordingly, the composition may be used as a coating composition, especially for the coating of articles in foundries and other operations which process liquid metal and also in water treatment plants.

The coating composition can in principle be stored and transported well, but in some embodiments it does not keep for an unlimited time. Preference can therefore be given to producing the composition just before it is applied to an article. It is particularly preferably produced by a kit which comprises a component A which consists at least partly of water glass and also a component B which is free of water glass and comprises at least one glass frit and hard material particles, preferably also solvents.

The coating composition is accordingly produced, in preferred forms, using such a kit, in particular directly (from some minutes to some hours) before being applied to a substrate. A corresponding process for producing a layer or coating comprises as steps the production of a coating composition mixing the components A and B of the kit, application of the composition formed from A and B to an article and subsequent drying of the applied composition, in particular at room temperature. The applied composition is preferably subsequently hardened, which has been described above.

The component A of the kit can also contain further components, in particular auxiliary additives (one or more), in preferably small amounts in addition to the water glass. In principle, it can also contain a proportion of hard material particles and/or the at least one glass frit as long as these do not react with the water glass at room temperature. However, the component A is preferably exclusively water glass, at the outside with small proportions of one or more auxiliary additives.

The individual components of the kit, i.e., the water glass, the at least one glass frit, the hard material particles and the solvent which may, if appropriate, be present in component B (and can also be present as separate component C in the kit) and the auxiliary additives which may, if appropriate, be present in component A, have been comprehensively described above.

Further features can be derived from the following description of preferred forms. The individual features can in each case be realized either individually or in combination with one another. The particular forms described serve merely for the purposes of illustration and for better understanding and do not restrict the scope of the appended claims in any way.

### EXAMPLE 1

A preferred form of a composition comprises the following constituents:
Component A:
   319.25 kg of an aqueous boron nitride suspension (solids content: 40% by weight)
   79.81 kg of an aqueous Cr₂O₃ suspension (solids content: 40% by weight, manufacturer: Bayer AG)
   79.81 kg of an aqueous Al₂O₃ suspension (solids content: 77.8% by weight, manufacturer: Alcoa)
   159.63 kg of an aqueous zirconium oxide suspension (solids content: 77.6% by weight, manufacturer: Kynol)
Component B:
   230.76 kg of potassium water glass (solids content: 40% by weight, Betolin K28, from Woellner Silicat GmbH)
   29.50 kg of magnesium oxide powder (manufacturer: CalMags GmbH)
   100.63 kg of a milled glass frit mixture in water (solids content: 50% by weight, manufacturer: Ferro)
   0.52 kg of Theological additive (xanthan gum from Deuteron XG)

The composition thus consists of the components A and B which are stored separately before use. Prior to application, the components A and B are mixed. The composition will not keep for an unlimited time in the finished mixed state.

The composition after mixing of the components A and B has a density of 1.45-1.51 g/cm³, a solids content of 49-51% by weight and a pH of from 11.25 to 11.30.

Application of the composition to an article is preferably effected by spraying. After drying of the composition, the resulting coating is thermally strengthened (baked) at high temperatures.

The composition was applied to a heat-exchange tube made of steel in a combustion plant and dried. The subsequent thermal hardening of the layer formed occurred during running-up of the plant. The layer thickness was about 120 μm. After operation of the plant for 90 days at temperatures of up to 800° C., only light ash or solid deposits could be observed on the layer. These could be removed easily, with the coating still being completely intact. In contrast, in a test using a comparable heat-exchange tube without the layer, a thick layer of ash and solid deposits and severe scale formation was observed after 90 days.

### EXAMPLE 2

A further preferred form of a composition comprises the following constituents:
Component A:
   11.85 kg of deionized water
   4.74 kg of boric acid (4% strength)
   5.22 kg of an aqueous Al₂O₃ suspension (solids content: 78% by weight, from Alcoa)
   5.93 kg of a milled glass frit (manufacturer: Ferro)
   5.93 kg of a milled glass frit (manufacturer: Pemco)
   0.38 kg of Byk 420
Component B:
   0.95 kg of sodium water glass. (Silmaco 48/50)

The composition thus consists of the components A and B which are stored separately before use. Only prior to application are the components A and B mixed. The composition will not keep for an unlimited time in the finished mixed state.

The composition after mixing-of the components A and B has a density of 1.29 g/cm³, a solids content of 47% by weight and a pH of <11.5 (pH of component A is 8.4).

Application of the composition to an article is preferably effected by spraying. After drying of the composition, the resulting coating is thermally strengthened (baked) at high temperatures.

The composition was applied to a heat-exchange tube made of steel in a combustion plant and dried. The subsequent thermal hardening of the layer formed occurred during running-up of the plant. The layer thickness was about 80 μm. After operation of the plant for 90 days at temperatures of up to 800° C., only light ash or solid deposits could be observed on the layer. These could be removed easily, with the coating still being completely intact. In contrast, in a test using a comparable heat-exchange tube made of steel without the layer, a thick layer of ash and solid deposits and severe scale formation was observed after 90 days.

1-37. (canceled)

38. A composition for producing a layer or coating which is stable at high temperatures which comprises:
water glass,
at least one glass frit,
hard material particles and
solvent.

39. The composition as claimed in claim 38, wherein the water glass comprises a potassium water glass.

40. The composition as claimed in claim 38, wherein the water glass comprises a sodium water glass.

41. The composition as claimed in claim 38, wherein the water glass is in the form of its aqueous solution.

42. The composition as claimed in claim 38, wherein the at least one glass frit comprises, as chemical constituents, SiO₂, B₂O₃, Al₂O₃ and alkali metal oxides.

43. The composition as claimed in claim 38, wherein the at least one glass frit comprises, as chemical constituents, SiO₂, B₂O₃, Al₂O₃ and alkaline earth metal oxides.

44. The composition as claimed in claim 38, wherein the at least one glass frit comprises at least one compound from the group consisting of TiO₂, ZnO, CuO, MnO, ZrO₂ and NiO.

45. The composition as claimed in claim 38, wherein the at least one glass frit comprises at least one inorganic fluoride.

46. The composition as claimed in claim 38, wherein the at least one glass frit is free of BaO.

47. The composition as claimed in claim 38, wherein the at least one glass frit is free of ZrO₂.

48. The composition as claimed in claim 38, wherein the at least one glass frit has an average particle size of from about 1 μm to about 10 μm.

49. The composition as claimed in claim 38, wherein the hard material particles have a hardness of >6 on Mohs' scale.

50. The composition as claimed in claim 38, wherein the hard material particles comprise at least one member selected from the group consisting of siliceous particles, oxidic particles, particles of titanates, particles of zirconates and particles of spinel compounds.

51. The composition as claimed in claim 38, wherein the hard material particles comprise at least one member selected from the group consisting of magnesium aluminate, (Fe, Mg)Cr₂O₄, zirconium oxide, zirconium silicate, zirconium phosphate, cordierite, mullite, sintered mullite, zirconium mullite, chromite, aluminum oxide, chromium oxide, calcium oxide, magnesium oxide and titanium dioxide particles.

52. The composition as claimed in claim 38, wherein the solvent is polar.

53. The composition as claimed in claim 38, wherein the solvent comprises water as a main constituent.

54. The composition as claimed in claim 38, which is essentially free of nanosize particles having average particle sizes of <100 nm.

55. The composition as claimed in claim 38, further comprising boron nitride.

56. The composition as claimed in claim 38, further comprising chromium(III) oxide.

57. The composition as claimed in claim 38, further comprising boric acid.

58. The composition as claimed in claim 38, further comprising inorganic particles as fillers.

59. The composition as claimed in claim 38, having a solids content of from about 25% by weight to about 60% by weight.

60. The composition as claimed in claim 38, further comprising at least one auxiliary additive.

61. The composition as claimed in claim 38, wherein the water glass is present in an amount of about 1% by weight to about 30% by weight.

62. The composition as claimed in claim 38, wherein the at least one glass frit is present in an amount of about 1% by weight to about 90% by weight.

63. The composition as claimed in claim 38, wherein the hard material particles are present in an amount of about 1% by weight to about 80% by weight.

64. The composition as claimed in claim 38, which comprises:
about 1% by weight-about 10% by weight of potassium water glass,
about 1% by weight-about 15% by weight of at least one glass frit,
about 1% by weight-about 15% by weight, of aluminum oxide,
about 1% by weight-about 20% by weight of zirconium oxide,
about 1% by weight-about 10% by weight of magnesium oxide,
about 5% by weight-about 15% by weight of boron nitride,
about 1% by weight-about 10% by weight of chromium(III) oxide,
about 0.1% by weight-about 5% by weight of at least one auxiliary additive; and
about 40% by weight-about 60% by weight of water.

65. The composition as claimed in claim 38, which comprises:
about 1% by weight-about 10% by weight of sodium water glass,
about 20% by weight-about 45% by weight of at least one glass frit,
about 5% by weight-about 20% by weight of aluminum oxide,
about 0.1% by weight-about 5% by weight of boric acid,
about 0.1% by weight-about 5% by weight of at least one auxiliary additive; and
about 40% by weight-about 60% by weight of water.

66. A layer or coating which is stable at high temperatures and comprises the composition as claimed in claim 38.

67. The layer or coating as claimed in claim 66, comprising a vitreous matrix.

68. The layer or coating as claimed in claim 66, comprising a silicate.

69. The layer or coating as claimed in claim 66, comprising hard material particles.

70. The layer or coating as claimed in claim 66, comprising boron nitride particles.

71. The layer or coating as claimed in claim 66, comprising boric acid.

72. The layer or coating as claimed in claim 66, comprising chromium(III) oxide.

73. The layer or coating as claimed in claim 66, which is essentially gastight.

74. The layer or coating as claimed in claim 66, having a thickness of about 10 μm to about 200 μm.

75. An article which is at least partly coated with a layer or coating as claimed in claim 66.

76. A kit for producing a coating composition as claimed in claim 38, which comprises a component A which comprises at least partly of water glass and a component B which is free of water glass and comprises at least one glass frit and hard material particles.
